(19) United States
(12) Patent Application Publication
(10) Pub. No.: US 2017/0172186 A1
(43) Pub. Date: Jun. 22, 2017

(54) APPARATUS FOR GENERATION OF PULSED FLOW FOR IMPINGEMENT HOODS

(71) Applicant: Michael D. Newman, Hillsborough, NJ (US)

(72) Inventor: Michael D. Newman, Hillsborough, NJ (US)

(21) Appl. No.: 15/367,399

(22) Filed: Dec. 2, 2016

Related U.S. Application Data
(60) Provisional application No. 62/270,662, filed on Dec. 22, 2015.

(51) Int. Cl. A23L 3/36

(52) U.S. Cl. CPC A23L 3/361

(57) ABSTRACT

In a freezer having an internal space therein in which a blower and an impingement plate are disposed and through which a conveyor for a food product passes, an impingement apparatus, includes a hood disposed at the internal space for coacting with the blower and the impingement plate, the hood including a sidewall defining a sub-chamber in which the blower is received; and a pipe having an end opening into the sub-chamber for introducing a pulse of cryogen to the sub-chamber for increasing a pressure in the sub-chamber and contacting the impingement plate. A related method is also provided.

### BACKGROUND OF THE INVENTION

The present embodiments relate to impingement freezing in cryogenic food freezing tunnels and in particular, to heat transfer which occurs with pulsed impingement apparatus in the tunnels.

Known cryogenic food freezers, such as a food freezing tunnel, have restricted capacity to process food products due to overall, limited heat transfer coefficients. That is, many known food freezing tunnels rely upon increasing air flow velocity across the food product in order to provide a commensurate increase in heat transfer rate at the products. There are, however, practical and economic limitations when increasing heat transfer with these known processes.

It is also known to be necessary to remove snow and ice accumulation from the impingement plates used with various food freezing tunnels. To date, pneumatically powered mechanical vibrators coact with the impingement plates to remove any accumulated snow and ice from the holes in the plates. However, such mechanical vibrating devices require increased maintenance and can fail under cryogenic temperatures during the freezing applications, especially when such devices are subjected to excessive humidity. These aspects of the devices can result in compromising the freezing process efficiency for the food products.

### SUMMARY OF THE INVENTION

The present embodiments provide increases in overall heat transfer rates which permit smaller food freezing tunnels to be fabricated and used, or permit production rates to be increased with existing tunnels.

The present embodiments provide pulsing impingement jets in an impingement freezing tunnel to increase the overall heat transfer rate of same.

The present embodiments obviate the need for using known pneumatically powered mechanical vibrators with impingement plates and therefore, substantially reduce if not eliminate the chance that the food processing line will be compromised if such vibrators fail during exposure to the cryogenic temperatures and high humidity conditions.

Therefore, an apparatus embodiment for generation of a cryogen pulsed flow for impingement hoods in freezers includes a hood constructed and arranged to coact with an impingement plate and a blower of a freezer to provide a sub-chamber in the freezer atmosphere in which pressure waves are generated to contact the impingement plate and increase velocity of impingement jets from the plate.

A method embodiment is also provided for providing pulsed flows for impingement hoods in freezers which includes constructing and arranging the impingement hood for providing a sub-chamber within the freezer proximate an impingement plate of the freezer, generating a pressure wave of a cryogen substance, introducing the pressure wave into the sub-chamber, and contacting the impingement plate for clearing snow and ice from said plate and increasing a velocity of impingement jets from the plate.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a side plan view in cross-section of a freezer tunnel with an apparatus for generating pulsed flow for impingement hoods according to the present embodiments;

FIG. 2 shows a side view of another embodiment of the pulse flow apparatus of the present invention; and

FIG. 3 shows a top plan view of the apparatus shown in FIG. 2.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

Basically, an impingement freezer apparatus of the present embodiments includes at least one and for certain applications a plurality of separate and discreet internal impingement hoods, each of which is fluidly connected to a source of high pressure nitrogen gas (N₂) controlled by a solenoid valve between the nitrogen source and the respective hood. The nitrogen is introduced under a pressure greater than that under the hood to provide an pressure pulse from the hood onto the underlying impingement plate(s) which provides a pressure wave to contact the plates and clear snow and/or ice from the plates (and holes disposed therein) positioned between the hood and the underlying food product being conveyed for freezing, and to provide a pulse to the nitrogen flow through impingement holes in the plate onto the underlying food product.

Impingement pulses are most effective when generated as close as possible to the heat transfer surface, which in this case are food products, for example. It is also more practical to generate the pulses in an enclosed volume of space. This is because as the volume of the cavity or space around the heat transfer surface becomes enlarged, a dampening effect is created which minimizes the degree of pulsation which can be achieved.

In the present embodiments, one or a plurality of separate and discrete impingement hoods are positioned in a freezer for generating a plurality of pulsed impingement jets. The reduced volume or sub-chamber defined by the hood is a more suitable environment to facilitate generating effective, heat transfer pulses. The pressure in the atmosphere within each one of the hoods where impingement jets are generated is at 2-3 inches of water column.

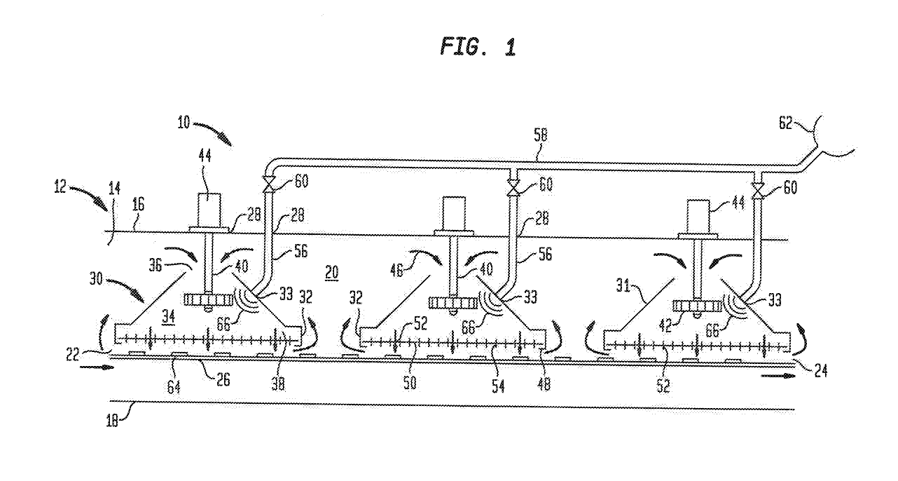

Pressure pulses are generated by introducing high pressure, small volumes of nitrogen gas into the hood spaces or sub-chambers. See FIG. 1 which shows a plurality or an array of three impingement hoods, by way of example only. A high pressure cryogen gas pipe is connected to the inside of each impingement hood. By way of example, nitrogen (N₂) gas is delivered through the pipe. A high frequency solenoid valve is placed within the high pressure nitrogen pipeline. A high pressure nitrogen gas manifold extends along a length of the freezer to a high pressure nitrogen gas storage tank. Gas pressure in this tank can be held in excess of 200 psig.

The individual solenoid valves open and close at a rate which corresponds to a desirable pulsed impingement flow to the respective hoods. As the solenoid valve opens a high pressure volume of nitrogen gas is introduced into the sub-chamber defined by the hood. The solenoid valve is then closed and a pulsed pressure wave is created in the hood. The pressure wave serves two purposes: first, it provides a slight increase in overall hood pressure which results in an impingement jet pulse from the hood, and second, the pressure wave assists with clearing snow and ice from the impingement plates.

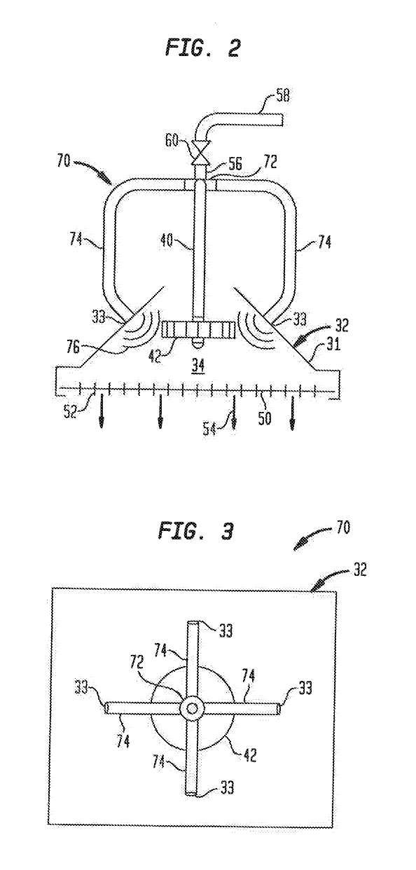

The high pressure gas connections for the nitrogen to the hood should be arranged symmetrically with respect to the hood, as shown for example in FIGS. 2-3, so that an even distribution of a pressure wave within the hood is provided to the impingement plate disposed at an enclosed portion of the hood above the underlying food product being transported on the conveyor. The greater a number of gas connections used will permit customizing or optimizing of the pulse rate (volume of nitrogen injected vs. time) of the nitrogen gas pressure waves to the impingement hoods and as a result the pulsed rate of impingement jets.

Referring in particular to FIGS. 1-3, a freezer apparatus embodiment of the present invention is shown generally at 10 which includes a housing 12 with sidewalls 14, a top 16, and a bottom 18, all of which define an interior chamber 20 or internal space of the housing. The housing 12 includes an inlet 22 at one end thereof, and an outlet 24 at another end thereof, the inlet and outlet being in fluid communication with the internal space 20. A conveyor belt 26 is arranged for movement from the inlet 22 through the internal space 20 and to exit out the outlet 24. The conveyor belt 26 can be of the type used with cryogen freezer tunnels, such as stainless steel mesh-type belt. A plurality of access holes 28 are arranged in the top 16 of the housing 12 for a purpose to be described hereinafter.

As shown in FIG. 1, at least one and for certain applications a plurality of pulsed flow apparatus embodiments (pulse apparatus) are shown generally at 30. Each one of the pulse apparatus 30 includes an impingement hood 32 of a rectangular, circular or any other cross-sectional shape, which defines a sub-chamber 34 with a sub-atmosphere within confines of the hood. The impingement hood 32 includes an upper end with an upper opening 36 and a lower end with a lower opening 38.

The upper opening 36 is sized and shaped to receive a shaft 40 for a blower 42 disposed in the sub-chamber 34. The shaft 40 is connected to a motor 44 mounted external to the housing 12 at, for example, the top 16 of the housing. The shaft 40 extends through one of the access holes 28 in the top 16 to be mechanically connected to the motor 44.

The upper opening 36 is also of a sufficient diameter to provide clearance between the shaft 40 and an edge of the upper opening so that gas flow 46 circulating in the internal space 20 can be drawn through the upper opening and thereafter into the sub-chamber 34.

The lower opening 38 has at is lower most edge a lip 48 circumscribing the lower opening upon which is supported at impingement plate 50. The impingement plate 50 is formed with a plurality of holes 52 through which streams or impingements jets 54 are directed to the underlying conveyor belt 26. The impingement plate 50 rests on the lip 48 to be supported in position above the underlying conveyor belt 26. Each one of the pulse apparatus 30 includes a sidewall 31 having formed therein a port 33 or hole in fluid communication with a cryogen gas pipe 56 which similarly extends through an access hole 28 at the top 16 of the housing to be connected to a pipe manifold 58 external to the housing. A solenoid valve 60 is disposed in the cryogen gas pipe 56 downstream of the pipe manifold 58. The pipe manifold 58 delivers cryogen gas under pressure, such as gaseous nitrogen, from a nitrogen gas storage tank 62 disposed at a remote location.

Food product 64 is transported by the conveyor belt 26 from the inlet 22 through the internal space 20 to the outlet 24 for chilling and/or freezing, depending upon the type of food product being processed. The food product 64 can include, but is not limited to, hamburger patties, chicken breasts, shrimp, fish, bakery products or other individual quick frozen (IQF) products.

Referring to FIGS. 2-3, an alternate embodiment of the pulse flow apparatus is shown generally at 70. The pulse flow apparatus 70 includes many of the same components as the pulse apparatus 30, except for the following. The embodiment 70 of the impingement hood 32 includes a plurality of the ports 33 or holes, only two of which are shown in FIG. 2 due to the perspective shown in the view of this figure. The pipe manifold 58 is in fluid communication with the cryogen gas pipe 56 and the solenoid valve 60 is disposed to interconnect the manifold 58 and the pipe 56. The cryogen gas pipe 56 is in fluid communication with a universal joint connection 72 which is branched into a plurality of distribution pipes 74, each one of which extends through a corresponding one of the ports 33 in the sidewall 31 of the hood 32, resulting in a plurality of pulses being introduced into the sub-chamber 34 as will be described below.

In operation and referring to the embodiment of FIG. 1, the freezer 10 is cooled down to operating conditions (usually approximately −100° C.). The solenoid valve 60 is in the closed position. The main impingement blowers 42 inside the impingement hoods 32 are brought up to operating speed. Nitrogen gas from the internal space 20 is drawn into the hoods from upper opening 36 and through the blowers 42. A back pressure is generated upstream of the impingement plates 50 and thus, an operating pressure inside the hoods 32 is maintained (2-3 inches of water column). The now established differential pressure across the impingement plates 50 allows for high velocity flow to be generated through the Impingement holes 52. At this steady state operating condition, the pulsing effect can be introduced into the sub-chamber 34. Accordingly, solenoid valve 60 is opened for a predetermined period of time (from approximately 0.5-2 seconds) to allow a volume of high pressure nitrogen gas (200 psig) from tank 62 to enter the impingement hood 32 sub-chamber 34 as a pressure pulse 66 or a wave. The pressure inside the impingement hood 32 is immediately increased which results in an increased impingement jet velocity through the holes 52 of the impingement plate 50. The pressure pulse 66 serves two purposes: i) it clears the plate 50 and the holes 52 of frozen concentrate, snow and/or ice and ii) it increases the velocity of the impingement jets 54 impacting the food product 64 to increase heat transfer at the food product. The solenoid valve 60 is then closed, resulting in a rapid drop of pressure within the impingement hood 32 at the sub-chamber 34. The resulting impingement jet velocity decreases. The pressure pulse 66 process by opening and closing the solenoid value 60 continues with the net result being rapidly changing impingement jet velocities (ie, pulses) discharged from the impingement plate 50 through the holes 52 onto the surface of the food product 64. A pulse rate of the wave must is adjusted so that the impingement jets 54 are never fully developed to be in an unwanted laminar flow. The pulsing action results in increased convective turbulence at the food product 64 surface which results in increased convective heat transfer, and clears the plate 50 and the holes 52 of any frozen condensate, ice and snow.

In operation and referring to FIGS. 2-3, the alternate embodiment 70 includes a plurality of distribution pipes 74 connected to a universal joint connection 72 so that the nitrogen gas can be evenly distributed during introduction of same into the sub-chamber 34 of the impingement hood 32. With the pulse flow apparatus 70, pressure pulses 76 or waves are introduced from a plurality of the distribution pipes 74 and therefore from a plurality of different directions for contacting the impingement plate 50. The pulses 76 can be introduced uniformly and simultaneously into the sub-chamber 34. The pressure pulses 76 contact a greater amount of the surface area of the plate 50 in a more uniform manner than the embodiment of FIG. 1 for dislodging and removing any snow or ice which may have accumulated in the holes 52 of the impingement plate 50. The plurality of pulses 76 can be of uniform pressure which results in an even amount of pressure being exerted on the plate 50. In addition, the jets exiting the holes 52 onto the underlying food product 64 are more uniform in intensity and distribution to the food product for increased heat transfer at the product.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. In a freezer having an internal space therein in which a blower and an impingement plate are disposed and through which a conveyor for a food product passes, an impingement apparatus, comprising:
a hood disposed at the internal space for coacting with the blower and the impingement plate, the hood including a sidewall defining a sub-chamber in which the blower is received; and
a pipe having an end opening into the sub-chamber for introducing a pulse of cryogen to the sub-chamber for increasing a pressure in the sub-chamber and contacting the impingement plate.

2. The impingement apparatus of claim 1, wherein the sidewall further comprises a first opening for drawing atmosphere of the internal space into the sub-chamber, and a second opening through which the pulse is exhausted at the impingement plate.

3. The impingement apparatus of claim 1, further comprising a valve interposed for fluid communication with the pipe for providing a plurality of the pulses intermittently to the sub-chamber.

4. The impingement apparatus of claim 1, wherein the cryogen comprises nitrogen.

5. The impingement apparatus of claim 2, wherein the impingement plate is positioned at the second opening of the sidewall.

6. The impingement apparatus of claim 5, wherein the sidewall further comprises a lip circumscribing the second opening and upon which the impingement plate is supported.

7. The impingement apparatus of claim 1, further comprising a universal joint connector at the pipe from which a plurality of pipe branches extend, each one of said pipe branches have a corresponding opening into the sub-chamber for introducing a corresponding pulse into the sub-chamber.

8. The impingement apparatus of claim 7, wherein the corresponding openings are uniformally spaced at the sidewall.

9. In a freezer having an internal space therein in which a blower and an impingement plate are disposed and through which a conveyor for a food product passes, a method for providing pulsed flows of cryogen in the freezer, comprising:
providing a sub-chamber in the internal space; and
generating a pressure wave of the cryogen at the internal space for pulsing the cryogen through the impingement plate.

10. The method of claim 9, wherein a first pressure at the sub-chamber is less than a second pressure of the pressure wave.

11. The method of claim 9, wherein the generating comprises generating a plurality of intermittently spaced pressure waves in the sub-chamber.

12. The method of claim 11, wherein the plurality of pressure waves do not produce a continuous laminar flow.

13. The method of claim 9, further comprising supporting the impingement plate at the hood for being contacted by the pulsing of the cryogen.

14. The method of claim 11, wherein the generating the plurality of intermittently spaced pressure waves are distributed symmetrically into the sub-chamber.

15. The method of claim 9, wherein the cryogen comprises nitrogen.
